(19) United States
(12) Patent Application Publication
(10) Pub. No.: US 2018/0239885 A1
(43) Pub. Date: Aug. 23, 2018

(54) USER EQUIPMENT WITH SMART BIOMETRIC UNLOCK

(71) Applicant: QUALCOMM Incorporated, San Diego, CA (US)

(72) Inventors: Akash KUMAR, Hyderabad (IN); Ashutosh GIRI, Hyderabad (IN); Ankita, Hyderabad (IN)

(21) Appl. No.: 15/459,928

(22) Filed: Mar. 15, 2017

Related U.S. Application Data
(60) Provisional application No. 62/461,514, filed on Feb. 21, 2017.

(51) Int. Cl. G06F 21/32; G06F 9/44; G06K 9/00

(52) U.S. Cl. CPC G06F 21/32; G06F 9/4418; G06K 9/0008; G06K 9/0002; G06K 9/00073; G06K 9/00087

(57) ABSTRACT

The apparatus of the disclosure provides a solution to the inconvenience currently faced while accessing the most frequently used applications by opening the most common application(s) using biometric authentication. For example, the apparatus may associate at least one biometric to a set of applications. The apparatus may detect a first interaction with the UE when the UE is in a locked mode. The apparatus may display a plurality of icons in a biometric area based on the first interaction. The apparatus may detect a second interaction with one of the plurality of icons displayed in the biometric area. The apparatus may determine if the at least one biometric is authenticated based on the second interaction. The apparatus may open an application associated with the one of the plurality of icons and unlocking the UE when the at least one biometric is authenticated.

### CROSS-REFERENCE TO RELATED APPLICATION(S)

This application claims the benefit of U.S. Provisional Application Ser. No. 62/461,514, entitled “USER EQUIPMENT WITH SMART BIOMETRIC UNLOCK” and filed on Feb. 21, 2017, which is expressly incorporated by reference herein in its entirety.

### BACKGROUND

### Field

The present disclosure relates generally to a user equipment (UE), and more particularly, to a technique for opening an application on the UE with reduced interaction by the user.

### Background

Modem UEs (e.g., mobile devices and/or smartphones) are not just used for making calls. Since the initial release of UEs, the number of functionalities that a UE provides has greatly increased. Some of the functionalities provided by a UE may be implemented using various applications (e.g., mobile applications or mobile apps) that are run on the UE.

A mobile application (e.g., application) is a software application designed to run on UEs. Most modern UEs are sold with several applications bundled as pre-installed software, such as a web browser, email client, calendar, mapping program, an application for buying music or other media or more applications. Applications that are not preinstalled are usually available through distribution platforms called “app stores”. Even when a UE is loaded with multiple applications, a user may only use a subset of the applications installed on the UE. For example, the most frequently used subset of applications may include the dialer application (e.g., used to make a call), the text application (e.g., used for sending text messages, a chat messenger (e.g., WhatsApp®), the UE's camera, an email application (e.g., Gmail® and/or a work email account), and/or a video-sharing application (e.g., YouTube).

To access an application installed on a UE, the user may have to unlock the UE, scroll through a list of installed applications and/or search for applications located on the UE's home screen, and select the desired application before the application is opened and available for use. The current technique for opening one of the frequently used applications on a UE may be a cumbersome and time consuming process for a user, especially when the user frequently accesses the application.

There is a need for a technique to provide access to an application run on the UE with reduced interaction on the part of the user.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

To access an application installed on a UE, the user may have to unlock the UE, scroll through a list of installed applications and/or search for applications located on the UE's home screen, and select the desired application before the application is opened and available for use. The current technique for opening one of the frequently used applications on a UE may be a cumbersome and time consuming process for a user, especially when the user accesses the application multiple times a day.

There is a need for a technique to provide access to an application run on the UE with reduced interaction on the part of the user.

The present disclosure provides a solution to the inconvenience currently faced while accessing frequently used applications by allowing such application(s) to be opened using biometric authentication. A UE configured with the biometric authentication technique of the preset disclosure may enable access to the frequently used application(s) quickly and with reduced interaction.

In an aspect of the disclosure, a method, a computer-readable medium, and an apparatus are provided. The apparatus may associate at least one biometric to a set of applications. In one aspect, the at least one biometric may be associated with each application in the set of applications. In addition, the apparatus may detect a first interaction with the UE when the UE is in a locked mode. Further, the apparatus may display a plurality of icons in a biometric area based on the first interaction. In an aspect, each of the plurality of icons may be associated with a different application in the set of applications. The apparatus may detect a second interaction with one of the plurality of icons displayed in the biometric area. The apparatus may determine if the at least one biometric is authenticated based on the second interaction. The apparatus may open an application associated with the one of the plurality of icons and unlocking the UE when the at least one biometric is authenticated. In one aspect, the application may be one in the set of applications.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIGS. 1A-1D are diagrams illustrating an example technique used to access a set of mobile application(s) using a bent side display screen of a UE in accordance with certain aspects of the disclosure.

FIGS. 2A-2D are diagrams illustrating an example technique used to access a set of mobile application(s) using an unbent side display screen of a UE in accordance with certain aspects of the disclosure.

FIGS. 3A and 3B are a flowchart of a method of opening an application on a UE when a biometric of a user is authenticated.

FIG. 4 is a conceptual data flow diagram illustrating the data flow between different means/components in an exemplary apparatus.

FIG. 5 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of UEs will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

To access an application installed on a UE, the user may have to unlock the UE, scroll through a list of installed applications and/or search for applications located on the UE's home screen, and select the desired application before the application is opened and available for use. The current technique for opening one of the frequently used applications on a UE may be a cumbersome and time consuming process for a user, especially when the user accesses the application multiple times a day.

There is a need for a technique to provide access to an application run on the UE with reduced interaction on the part of the user.

The present disclosure provides a solution to the inconvenience currently faced while accessing frequently used applications by using biometric authentication to open the applications and without further interaction by the user. A UE configured with the biometric authentication technique of the preset disclosure may enable a user to access a set of application(s) quickly and with reduced interaction.

Biometric information includes distinctive, measurable characteristics that may be used to identify and/or authenticate a specific user prior to providing access to a UE or to specific applications run on the UE. For example, the biometric information may be used to unlock a UE and allow a user to access one or more applications that are run on the UE.

Various types of biometric information (e.g., fingerprints, iris patterns, etc.) may be used to authenticate a user before unlocking a UE or opening an application run on the UE. Fingerprints are one of many forms of biometric information that may be used to authenticate a user. The analysis of fingerprints for identifying a user generally includes the comparison of several features of a user's fingerprint with stored fingerprint data of a user. The features of the fingerprint that may be used to authenticate a user include an aggregate of ridges, and/or minutia points, which are unique features specific to a user's finger. The three basic patterns of fingerprint ridges are the arch, loop, and whorl. The arch may refer to ridges that enter from one side of the finger, rise in the center forming an arc, and then exit the other side of the finger. The loop may refer to ridges that enter from one side of a finger, form a curve, and then exit on that same side. The whorl may refer to ridges that form circularly around a central point on the finger. One or more of the arch, loop, and/or whorl may be used in authenticating a user prior to gaining access to the UE and/or opening an application run on the UE.

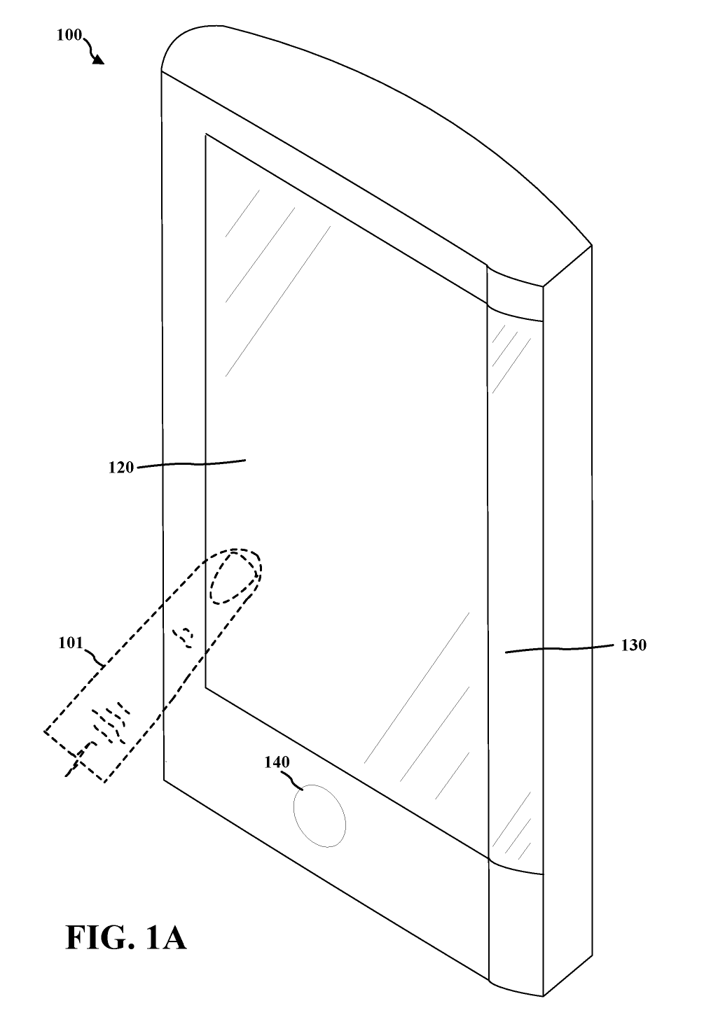

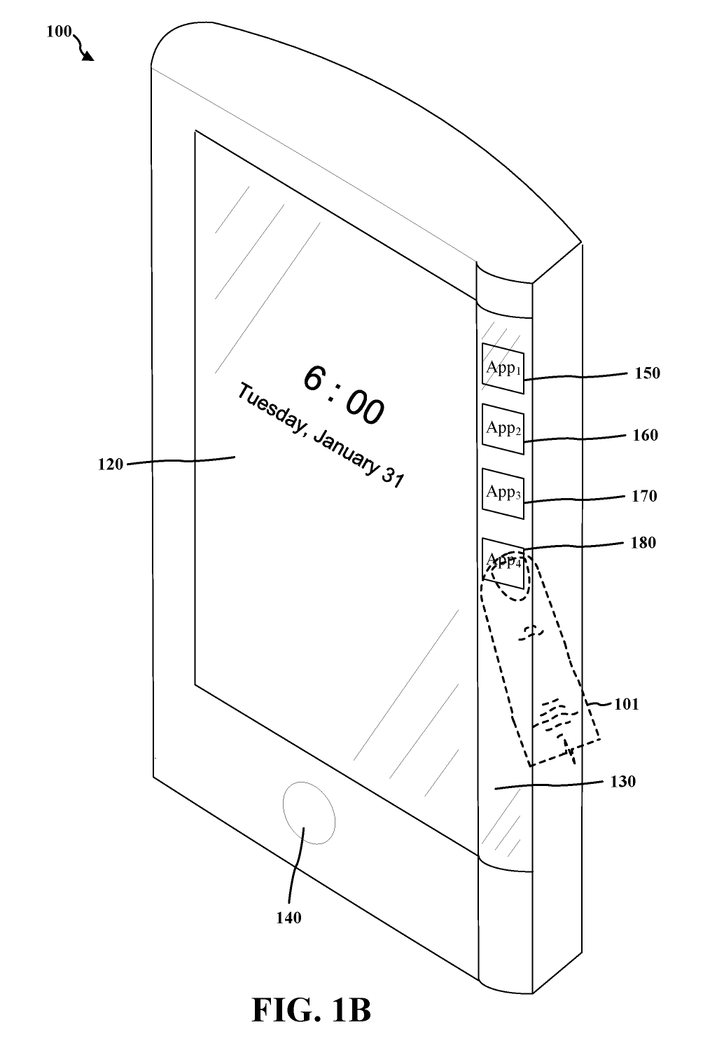

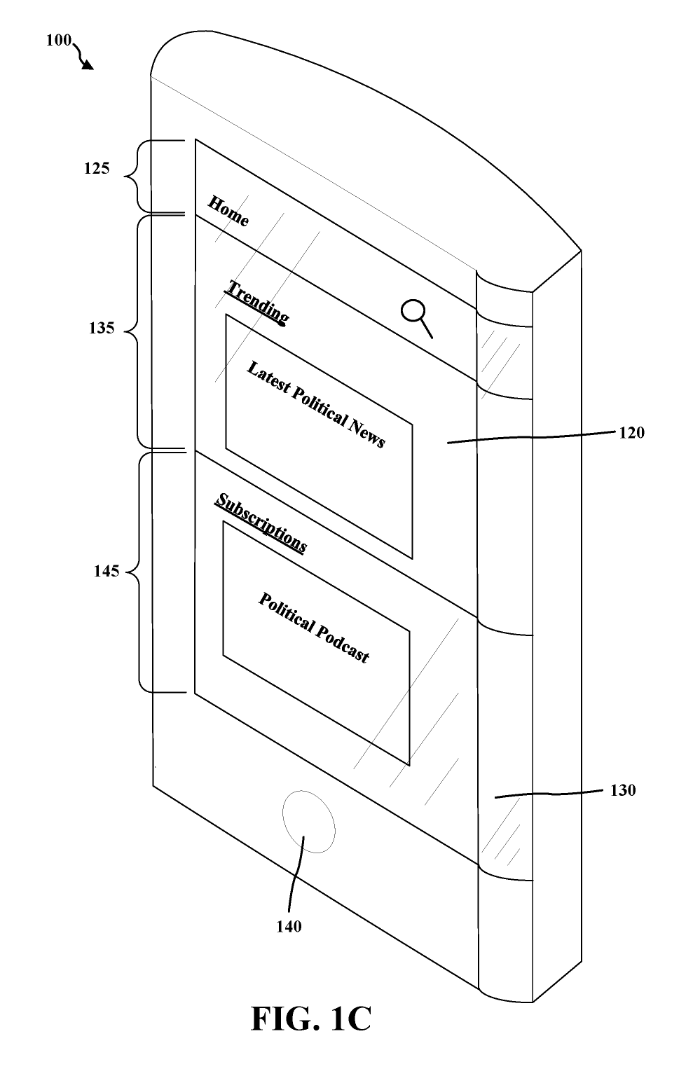

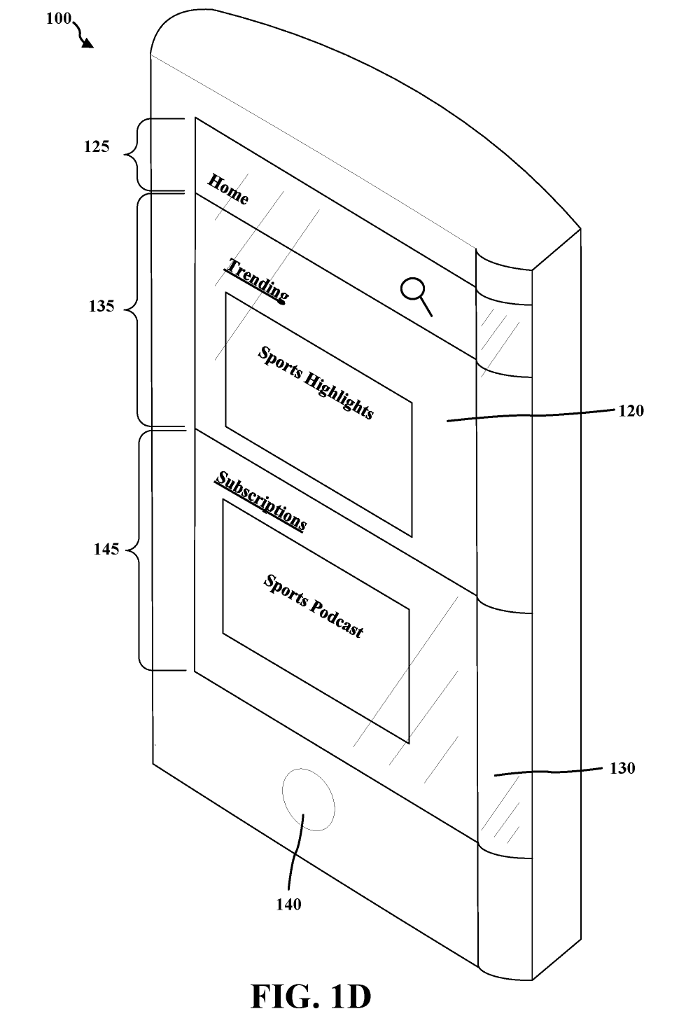

FIGS. 1A-1D illustrate an example embodiment of a UE that may provide a user with access to the application(s) quickly and with reduced interaction on the part of the user. For example, the UE 100 illustrated in FIGS. 1A-1D may store and/or have access to biometric information (e.g., for one or more users). The biometric information may be used to authenticate a user and open one or more applications associated with the user using the techniques described infra.

In one aspect, the user may select a set of applications that may be opened using the techniques described herein. For example, the user may launch a control and/or settings panel on the UE 100 that allows the user to view and manipulate basic system settings and controls, such as changing application accessibility. The user may change or select application accessibility so that a set of applications may be opened using the techniques described infra. In certain configurations, more than one user may have access to the UE 100, and each of the users may change or select application accessibility so that a set of applications specific to that user may be opened using the techniques described infra.

In addition, UE 100 may store and/or have access to a unique set of user characteristics associated with the biometric information for each user. For example, assume that the biometric information for two users is stored at the UE (e.g., each of the two users are allowed access to at least a portion of the applications run on the UE). UE 100 may open different versions of the same application for each of the two users based on the unique set of user characteristics. When the UE 100 opens a first version of the application (e.g. see FIG. 1C) associated with the first user, the UE 100 may display content tailored to the first user based on the set of first user characteristics. Alternatively, when the UE 100 opens a second version of the application (e.g., see FIG. 1D) associated with the second user, the UE 100 may display content tailored to the second user based on the set of second user characteristics. In one aspect, the set of characteristics associated with each user may include at least one of an age of the user, a gender of the user, a nationality of the user, one of more hobbies of the user, frequently searched content by the user, recently searched content by the user, music downloaded by the user, video game preferences associated with the user, a location of the user, etc.

FIG. 1A illustrates UE 100 in a the locked sleep mode. Sleep mode may include a mode when UE 100 is powered-on but when the display screens 120, 130 are not illuminated. Locked mode may include a mode when UE 100 is able to receive incoming calls, e-mail, text messages, emergency notifications, etc., but the user does not have access to one or more applications that are run on UE 100.

In one aspect, UE 100 may include a main display screen 120 and a side display screen 130. In one configuration, the main display screen 120 and the side display screen 130 may form a continuous, “bent” display screen (illustrated in FIG. 1A). In another configuration, the main display screen 120 and the side display screen may form a non-continuous, “bent” display screen (not illustrated in FIG. 1A). The non-continuous, “bent” display screen may include a break between the main display screen 120 and the side display screen 130. In either configuration, the side display screen 130 may be formed at an angle (e.g. not a 0° angle or 180° angle) and/or out of plane with respect to the main display screen 120.

When the user interacts (e.g., contacts, taps, touches, depresses, swipes, etc.) with the main display screen 120 and/or the side display screen 130 (e.g., using the user's finger 101), UE 100 may detect the interaction and transition from the locked sleep mode to the locked awake mode, as discussed infra with respect to FIG. 1B., UE 100 may transition from the locked sleep mode to the locked awake mode based on a user interaction with home button 140. In addition, one or more of the main display screen 120, the side display screen 130, and/or the home button 140 may include a biometric area that is configured to authenticate biometric information (e.g., fingerprint) of a user attempting to gain access to UE 100.

In one aspect, UE 100 may transition from the locked sleep mode to locked awake mode without performing biometric authorization based on the user interaction. In an alternative aspect, UE 100 may perform biometric authorization based on the first interaction before transitioning from the locked sleep mode to locked awake mode. If the UE 100 is not able to authenticate the biometric of the user based on the first interaction, the UE 100 may remain in a locked asleep mode.

FIG. 1B illustrates UE 100 after transitioning from locked sleep mode to locked awake mode. While in locked awake mode, UE 100 may display certain information (e.g., time, date, cellular signal strength, battery life, etc.) on the main display screen 120 and icons 150, 160, 170, 180 associated with one or more applications on side screen 130. In the locked awake mode, the user may not have access to applications run on UE 100. In certain configurations, when biometric authentication associated with the first interaction is successful, UE 100 may display icons 150, 160, 170, 180 associated with the user identified during biometric authentication of the first interaction.

In one aspect, the icons 150, 160, 170, 180 may be associated with the set of applications selected for application accessibility, as discussed infra. For example, assume that App₁, App₂, App₃, and App₄ are the set of applications selected by the user for application accessibility. In addition, assume App₁ is an email account for the user, App₂ is a social media account of the user, App₃ is a news application, and App₄ is a video-sharing application. In one configuration, when more than one user is authorized to use one or more of the applications on the UE 100, the icons associated with the set of applications selected by the primary user (e.g., parent, owner of the device, etc.) may be displayed whether the interaction is by the first user or the second user.

In addition, assume that side display screen 130 includes a biometric area over each of the displayed icons 150, 160, 170, 180, such that when the user interacts (e.g., contacts, taps, touches, depresses, swipes, etc.) with one of the icons 150, 160, 170, 180 displayed on the side display screen 130 (e.g., using the user's finger 101), the UE 100 may perform biometric authentication based on the user's fingerprint. In addition, UE 100 may recognize which icon the user has interacted with.

If the UE 100 is able to authenticate the captured biometric information of the user, then the UE 100 may transition from a locked awake mode to a unlocked awake mode and automatically open (e.g., launch, run, etc.) the application without further interaction by the user. In the example, illustrated in FIG. 1B, the user interacts with the icon 180 associated with App₄ (e.g., the video-sharing application). When the captured biometric information of the user is authenticated based on the second interaction, UE 100 may enter the unlocked awake mode and automatically open the video-sharing application without further interaction by the user, as discussed infra with respect to FIGS. 1C and 1D. If the UE 100 is not able to authenticate the biometric of the user based on the second interaction, then the UE 100 may remain in a locked wake mode and/or return to a locked sleep mode.

FIG. 1C illustrates UE 100 after transitioning from locked awake mode to unlocked awake mode after a first user is authenticated (e.g., the user in FIGS. 1A and 1B is the first user). After the captured biometric information of the first user is authenticated based on the second interaction (e.g., as discussed supra with respect to FIG. 1B), UE 100 may enter the unlocked awake mode and automatically open a first version of video-sharing application without further interaction by the first user. While in unlocked awake mode, UE 100 may display an application page (e.g., application home page, last page/screen of the application viewed by the user, etc.) on the main display screen 120 and/or side display screen 130 and enable the user to access the application.

In the particular example illustrated in FIG. 1C, a first video-sharing application (e.g., App₄ selected by the user in FIG. 1B) is displayed automatically after the captured biometric information of the first user is authenticated based on the second interaction. For example, the video-sharing application opened by the UE 100 may include a home navigation region 125, a trending video section 135, and a subscriptions section 145. Assume that the UE 100 determines that the first user is particularly interested in politics based on the set of user characteristics associated with the first user. Then, the UE 100 may open a version of the video-sharing application that provides the first user with a selection of trending political video content in the trending video section 135 and the political podcasts the first user subscribes to in the subscriptions section 145.

Additionally, when the user selects the email application (e.g., App₁ in FIG. 1B), a version of the email application associated with the user's login credentials (e.g., the username and password used to gain access to the user's email account) is displayed automatically. In certain configurations, UE 100 may open the email application using the user's login credentials so that the user has automatic access to the email account. In other configurations, UE 100 may open the login page of the email application so that the user has to enter login credentials before gaining access to the email account. Alternatively, if a second user selects the email application, a version of the email application associated with the second user's login credentials (e.g., the username and password used to gain access to the first user's email account) may be displayed automatically.

FIG. 1D illustrates UE 100 after transitioning from locked awake mode to unlocked awake mode after a second user is authenticated (e.g., the user in FIGS. 1A and 1B is the second user). After the captured biometric information of the second user is authenticated (e.g., as discussed supra with respect to FIG. 1B), UE 100 may enter the unlocked awake mode and automatically open a second version of video-sharing application without further interaction by the second user. While in unlocked awake mode, UE 100 may display an application page (e.g., application home page, last page/screen of the application viewed by the user, etc.) on the main display screen 120 and/or side display screen 130 and provide access to at least a portion of the UE 100 to the second user.

In the particular example illustrated in FIG. 1D, a second version of the video-sharing application (e.g., App₄ selected by the user in FIG. 1B) is displayed automatically after the captured biometric information of the second user is authenticated. For example, the second version of video-sharing application opened by the UE 100 may include a home navigation region 125, a trending video section 135, and a subscriptions section 145. Assume that the UE 100 determines that the second user is particularly interested in sports based on the set of user characteristics associated with the second user. Then, the UE 100 may open a version of the video-sharing application that provides the second user with a selection of trending sports highlights in the trending video section 135 and the sports podcasts the second user subscribes to in the subscriptions section 145.

By enabling UE 100 to open certain applications automatically after biometric authentication, the inconvenience currently faced by a user accessing an application may be avoided by reducing the number of user interactions needed to open an application.

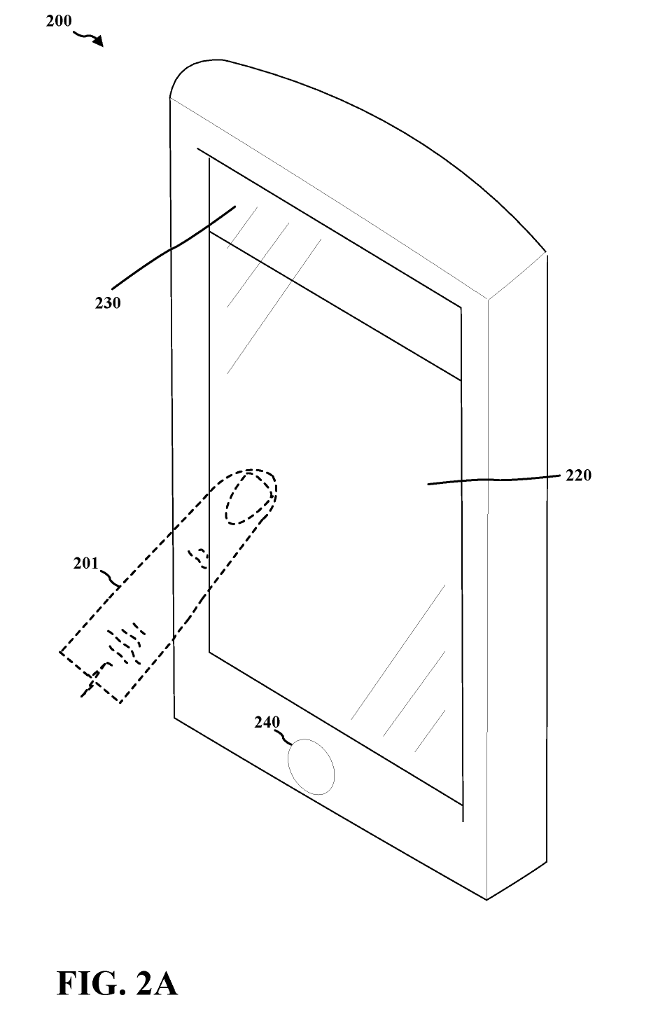

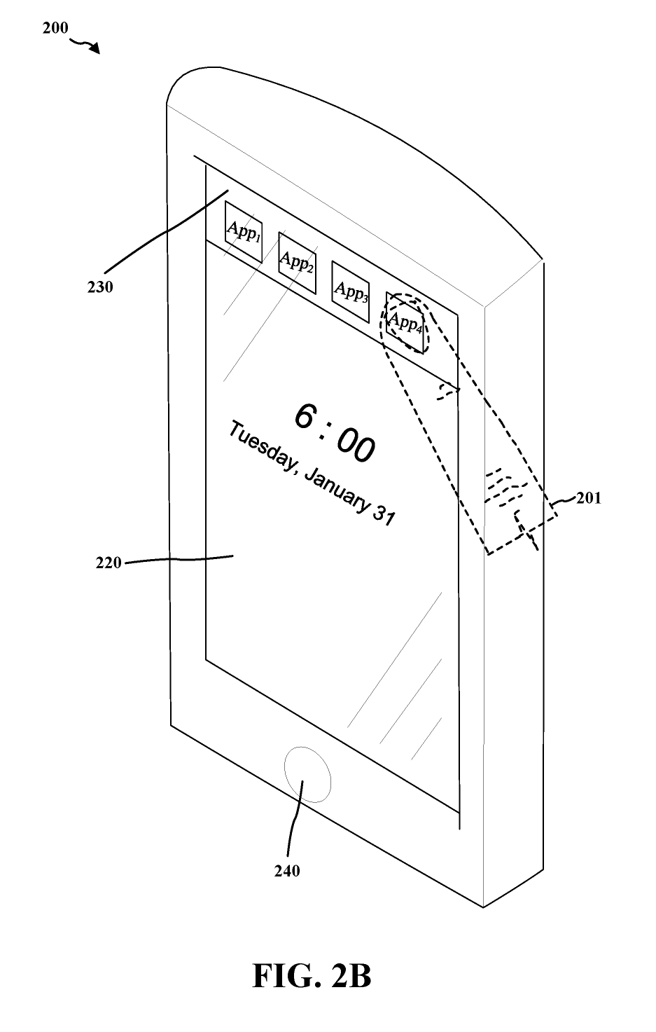

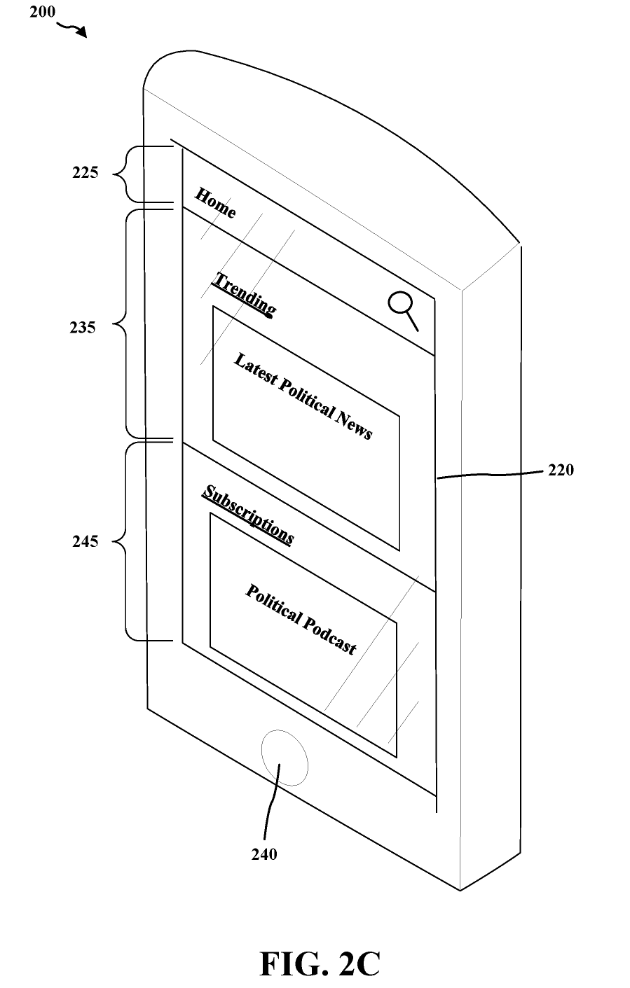

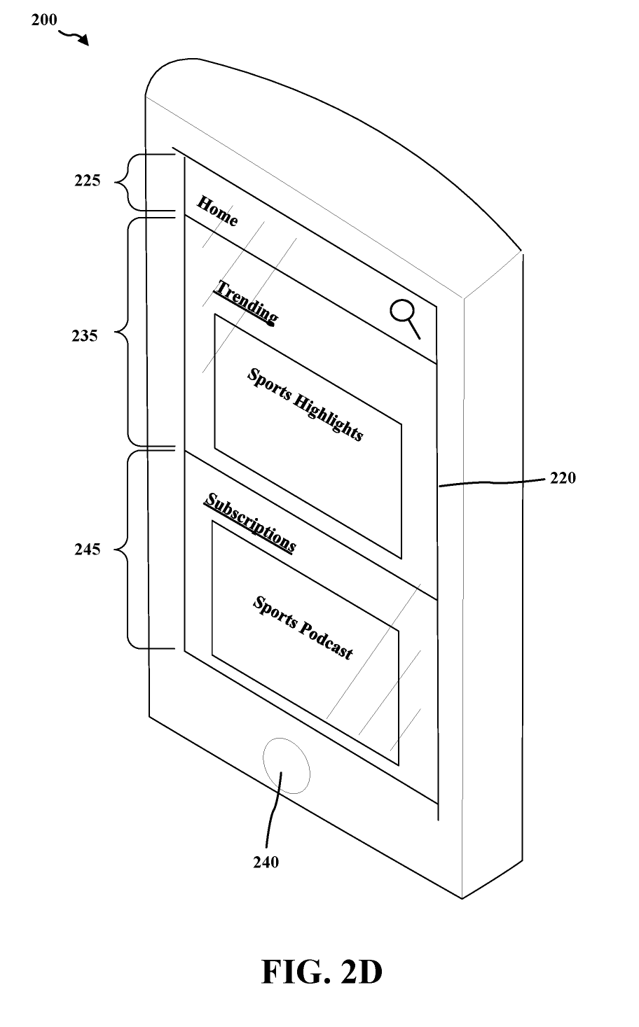

FIGS. 2A-2D illustrate an example embodiment of a UE that may provide a user with access to the application(s) quickly and with reduced interaction on the part of the user. For example, the UE 200 illustrated in FIGS. 2A-2D may store and/or have access to biometric information (e.g., for one or more users). The biometric information may be used to open one or more applications using the techniques described infra.

In one aspect, the user may select a set of applications that may be opened using the techniques described herein. For example, the user may launch a control and/or settings panel on the UE 200 that allows the user to view and manipulate basic system settings and controls, such as changing application accessibility. The user may change or select application accessibility so that a set of applications may be opened using the techniques described infra. In certain configurations, more than one user may have access to the UE 200, and each of the users may change or select application accessibility so that a set of applications specific to that user may be opened using the techniques described infra.

In addition, UE 200 may store and/or have access to a unique set of user characteristics associated with the biometric information for each user. For example, assume that the biometric information for two users is stored at the UE (e.g., each of the two users are allowed access to at least a portion of the applications run on the UE). UE 200 may open different versions of the same application for each of the two users based on the unique set of user characteristics of each user. When the UE 200 opens a first version of the application (e.g. see FIG. 2C) associated with the first user, the UE 200 may display content tailored to the first user based on the set of first user characteristics. Alternatively, when the UE 200 opens a second version of the application (e.g., see FIG. 2D) associated with the second user, the UE 200 may display content tailored to the second user based on the set of second user characteristics. In one aspect, the set of characteristics associated with each user may include at least one of an age of the user, a gender of the user, a nationality of the user, one of more hobbies of the user, frequently searched content by the user, recently searched content by the user, music downloaded by the user, video game preferences associated with the user, a location of the user, etc.

FIG. 2A illustrates UE 200 in a the locked sleep mode. Sleep mode may include when UE 200 is powered-on but when the display screens 220, 230 are not illuminated. Locked mode may include when UE 200 is able to receive incoming calls, e-mail, text messages, emergency notifications, etc., but the user does not have access to one or more applications that are run on UE 200.

In one aspect, UE 200 may include a main display screen 220 and a side display screen 230. In one configuration, the main display screen 220 and the side display screen 230 may form a continuous display screen. In another configuration, the main display screen 220 and the side display screen may form a non-continuous display screen (not illustrated in FIG. 2A). The non-continuous display screen may include a break between the main display screen 220 and the side display screen 230. In either configuration, the side display screen 230 may be formed in the same plane with respect to the main display screen 220.

When the user interacts (e.g., contacts, taps, touches, depresses, swipes, etc.) with the main display screen 220 and/or the side display screen 230 (e.g., using the user's finger 201), UE 200 may detect the interaction and transition from the locked sleep mode to locked awake mode, as discussed infra with respect to FIG. 2B. Optionally, UE 200 may transition from a the locked sleep mode to a locked awake wake mode based on a user interaction with home button 240. In addition, one or more of the main display screen 220, the side display screen 230, and/or the home button 240 may include a biometric area that is configured to authenticate biometric information (e.g., fingerprint) of a user attempting to gain access to UE 200.

In one aspect, UE 200 may transition from the locked sleep mode to the locked awake mode without performing biometric authorization based on the user interaction. In an alternative aspect, UE 200 may perform biometric authorization based on the first interaction before transitioning from the locked sleep mode to the locked awake mode. If the UE 200 is not able to authenticate the biometric of the user based on the first interaction, the UE 200 may remain in a locked asleep mode.

FIG. 2B illustrates UE 200 after transitioning from the locked sleep mode to locked awake mode. While in locked awake mode, UE 200 may display certain information (e.g., time, date, cellular signal strength, battery life, etc.) on the main display screen 220 and icons 250, 260, 270, 280 associated with one or more applications on side display screen 230. In locked awake mode, the user may not have access to applications run on UE 200. In certain configurations, when biometric authentication associated with the first interaction is successful, UE 100 may display icons 250, 260, 270, 280 associated with the user identified during biometric authentication of the first interaction.

In one aspect, the icons 250, 260, 270, 280 may be associated with the set of applications selected for application accessibility, as discussed infra. For example, assume that App₁, App₂, App₃, and App₄ are the set of applications selected by the user for application accessibility. In addition, assume App₁ is an email account for the user, App₂ is a social media account of the user, App₃ is a news application, and App₄ is a video-sharing application. In one configuration, when more than one user is authorized to use one or more of the applications on the UE 200, the icons associated with the set of applications selected by the primary user (e.g., parent, owner of the device, etc.) may be displayed whether the interaction is by the first user or the second user.

In addition, assume that side display screen 230 includes a biometric area over each of the displayed icons 250, 260, 270, 280, such that when the user interacts (e.g., contacts, taps, touches, depresses, swipes, etc.) with one of the icons 250, 260, 270, 280 displayed on the side display screen 230 (e.g., using the user's finger 201), the UE 200 may perform biometric authentication based on the user's fingerprint. In addition, UE 200 may recognize which icon the user has interacted with.

If the UE 200 is able to authenticate the captured biometric information of the user based on the second interaction, then the UE 200 may transition from a locked awake mode to a unlocked awake mode and automatically open (e.g., launch, run, etc.) the application without further interaction by the user. In the example, illustrated in FIG. 2B, the user interacts with the icon 280 associated with App₄ (e.g., the video-sharing application). When the captured biometric information of the user is authenticated based on the second interaction, UE 200 may enter the unlocked awake mode and automatically open the video-sharing application without further interaction by the user, as discussed infra with respect to FIGS. 2C and 2D. If the UE 200 is not able to authenticate the captured biometric information of the user, then the UE 200 may remain in a locked mode.

FIG. 2C illustrates UE 200 after transitioning from the locked awake mode to unlocked awake mode after a first user is authenticated (e.g., the user in FIGS. 2A and 2B is the first user). After the captured biometric information of the first user is authenticated based on the second user interaction (e.g., as discussed supra with respect to FIG. 2B), UE 200 may enter the unlocked awake mode and automatically open a first version of video-sharing application without further interaction by the first user. While in unlocked awake mode, UE 200 may display an application page (e.g., application home page, last page/screen of the application viewed by the user, etc.) on the main display screen 220 and/or side display screen 230 and enable the user to access the application.

In the particular example illustrated in FIG. 2C, a first video-sharing application (e.g., App₄ selected by the user in FIG. 2B) is displayed automatically after the captured biometric information of the first user is authenticated based on the second user interaction. For example, the video-sharing application opened by the UE 200 may include a home navigation region 225, a trending video section 235, and a subscriptions section 245. Assume that the UE 200 determines that the first user is particularly interested in politics based on the set of user characteristics associated with the first user. Then, the UE 200 may open a version of the video-sharing application that provides the first user with a selection of trending political video content in the trending video section 235 and the political podcasts the first user subscribes to in the subscriptions section 245.

Additionally, when the first user selects the email application (e.g., App₁ in FIG. 2B), a version of the email application associated with the first user's login credentials (e.g., the username and password used to gain access to the first user's email account) may be displayed automatically. In certain configurations, UE 200 may open the email application using the first user's login credentials so that the user has automatic access to the email account. In other configurations, UE 200 may open the login page of the email application so that the first user has to enter login credentials before gaining access to the email account. Alternatively, if a second user selects the email application, a version of the email application associated with the second user's login credentials (e.g., the username and password used to gain access to the first user's email account) may be displayed automatically.

FIG. 2D illustrates UE 200 after transitioning from the locked awake mode to unlocked awake mode after a second user is authenticated (e.g., the user in FIGS. 2A and 2B is the second user). After the captured biometric information of the second user is authenticated (e.g., as discussed supra with respect to FIG. 2B), UE 200 may enter the unlocked awake mode and automatically open a second version of video-sharing application without further interaction by the second user. While in unlocked awake mode, UE 200 may display an application page (e.g., application home page, last page/screen of the application viewed by the user, etc.) on the main display screen 220 and/or side display screen 230 and provide access to at least a portion of the UE 200 to the second user.

In the particular example illustrated in FIG. 2D, a second version of the video-sharing application (e.g., App₄ selected by the user in FIG. 2B) is displayed automatically after the captured biometric information of the second user is authenticated. For example, the second version of video-sharing application opened by the UE 200 may include a home navigation region 225, a trending video section 235, and a subscriptions section 245. Assume that the UE 200 determines that the second user is particularly interested in sports based on the set of user characteristics associated with the second user. Then, the UE 200 may open a version of the video-sharing application that provides the second user with a selection of trending sports highlights in the trending video section 235 and the sports podcasts the second user subscribes to in the subscriptions section 245.

By enabling UE 200 to open certain applications automatically after biometric authentication, the inconvenience currently faced by a user accessing an application may be avoided by reducing the number of user interactions needed to open an application.

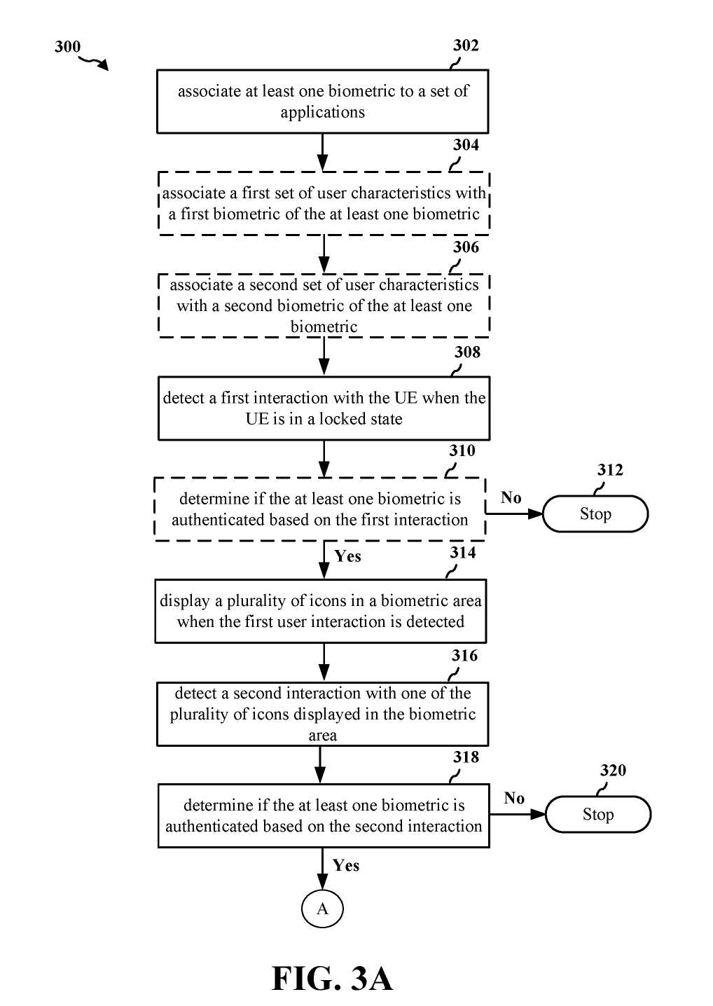

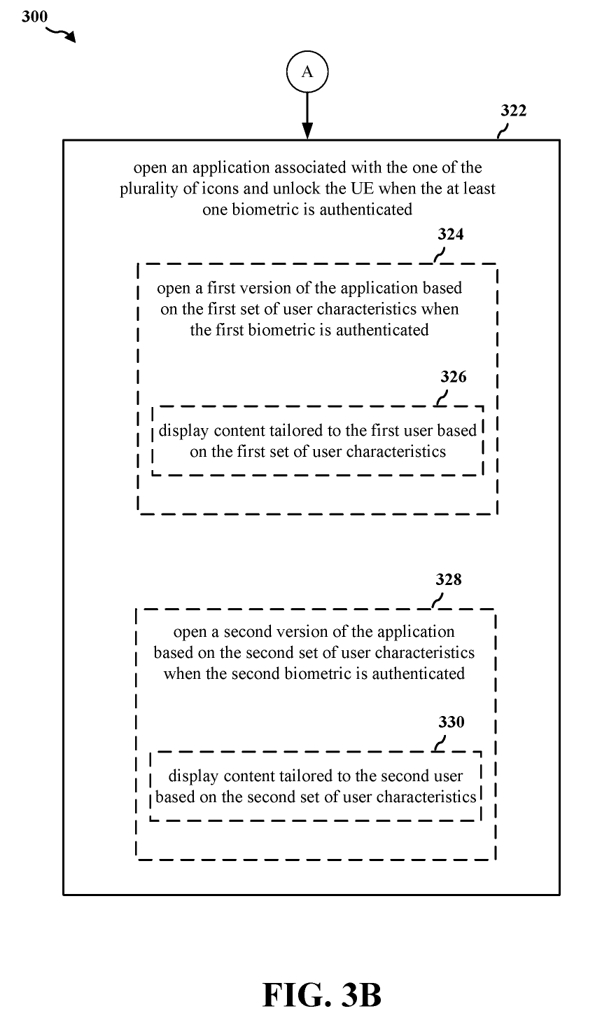

FIGS. 3A and 3B are a flowchart 300 of a method of opening an application in accordance with certain aspects of the disclosure. The method may be performed by a UE (e.g., the UE 100, 200, the apparatus 402/402′). In FIGS. 3A and 3B, operations indicated with dashed lines represent optional operations for various aspects of the disclosure.

In FIG. 3A, at 302, the UE may associate at least one biometric information to a set of applications. In one aspect, the at least one biometric may be associated with each application in the set of applications. In one aspect, the UE may use a look up table that correlates a user's biometric information to each application the user has selected to open using the techniques described with respect to FIGS. 1A-1D and 2A-2D. For example, referring to FIGS. 1A-1D and 2A-2D, UE 100, 200 may store and/or have access to biometric information (e.g., for one or more users). The biometric information may be used to unlock the UE 100, 200 and/or open one or more applications using the technique(s) described with respect to FIGS. 1A-1D and/or 2A-2D.

In FIG. 3A, at 304, the UE may associate a first set of user characteristics with a first biometric of the at least one biometric. In one aspect, the first set of user characteristics and the first biometric may be associated with a first user. For example, referring to FIGS. 1A-1D and 2A-2D, UE 100, 200 may store and/or have access to a first set of user characteristics associated with the biometric information for the first user. In one aspect, the set of characteristics associated with the first user may include at least one of an age of the first user, a gender of the first user, a nationality of the first user, one of more hobbies of the first user, frequently searched content by the first user, recently searched content by the first user, music downloaded by the first user, video game preferences associated with the first user, a location of the first user, etc.

In FIG. 3A, at 306, the UE may associate a second set of user characteristics with a second biometric of the at least one biometric. In one aspect, the second set of user characteristics and the second biometric may be associated with a second user. For example, referring to FIGS. 1A-1D and 2A-2D, UE 100, 200 may store and/or have access to a second set of user characteristics associated with the biometric information for the second user. In one aspect, the set of characteristics associated with the second user may include at least one of an age of the second user, a gender of the second user, a nationality of the second user, one of more hobbies of the second user, frequently searched content by the second user, recently searched content by the second user, music downloaded by the second user, video game preferences associated with the second user, a location of the second user, etc.

In FIG. 3A, at 308, the UE may detect a first interaction with the UE when the UE is in a locked mode. For example, the UE may detect pressure applied to certain areas of the display or may detect interaction using capacitive change in an area of display. In an aspect, the first interaction may cause the UE to enter a locked awake mode. For example, referring to FIG. 1A, when the user interacts (e.g., contacts, taps, touches, depresses, swipes, etc.) with the main display screen 120 and/or the side display screen 130 (e.g., using the user's finger 101), UE 100 may detect the interaction and transition from the locked sleep mode to the locked awake mode, as discussed supra with respect to FIG. 1B. Optionally, UE 100 may transition from the locked sleep mode to the locked awake mode based on a user interaction with home button 140. Referring to FIG. 2A, when the user interacts (e.g., contacts, taps, touches, depresses, swipes, etc.) with the main display screen 220 and/or the side display screen 230 (e.g., using the user's finger 201), UE 200 may detect the interaction and transition from the locked sleep mode to the locked awake mode, as discussed supra with respect to FIG. 2B. Optionally, UE 200 may transition from the locked sleep mode to the locked awake mode based on a user interaction with home button 240.

In FIG. 3A, at 310, the UE may determine if the at least one biometric is authenticated based on the first interaction. For example, referring to FIG. 1A, UE 100 may perform biometric authorization based on the first interaction before transitioning from the locked sleep mode to locked awake mode. Referring to FIG. 2A, UE 100 may perform biometric authorization based on the first interaction before transitioning from the locked sleep mode to locked awake mode.

In FIG. 3A, at 312, the UE may remain in a locked mode and stop the process of authentication when the at least one biometric is not authenticated based on the first interaction. For example, referring to FIGS. 1A, 1B, if the UE 100, 200 is not able to authenticate the biometric of the user based on the first interaction, the UE 100, 200 may remain in a locked asleep mode.

In FIG. 3A, at 314, the UE may display a plurality of icons in a biometric area when the first user interaction is detected, or optionally when the at least one biometric is authenticated based on the first interaction. In an aspect, each of the plurality of icons may be associated with a different application in the set of applications. For example, referring to FIG. 1B, UE 100 may transition from the locked sleep mode to the locked awake mode based on the user interaction. While in the locked awake mode, UE 100 may display icons 150, 160, 170, 180 associated with one or more applications on side screen 130. In the locked awake mode, the user may not have access to applications run on UE 100. In one aspect, the icons 150, 160, 170, 180 may be associated with the set of applications selected for application accessibility, as discussed supra. In addition, side display screen 130 may include a biometric area over each of the displayed icons 150, 160, 170, 180. Referring to FIG. 2B, UE 200 may transition from the locked sleep mode to the locked awake mode based on the user interaction. While in the locked awake mode, UE 200 may display icons 250, 260, 270, 280 associated with one or more applications on side display screen 230. In the locked awake mode, the user may not have access to applications run on UE 200. In one aspect, the icons 150, 160, 170, 180 may be associated with the set of applications selected for application accessibility, as discussed supra. In addition, side display screen 230 may include a biometric area over each of the displayed icons 250, 260, 270, 280. By way of example, in both FIGS. 1B and 2B, App₁, App₂, App₃, and App₄ may be the set of applications selected by the user for application accessibility. In addition, assume App₁ is an email account for the user, App₂ is a social media account of the user, App₃ is a news application, and App₄ is a video-sharing application.

In FIG. 3A, at 316, the UE may detect a second interaction with one of the plurality of icons displayed in the biometric area. For example, the UE may detect pressure applied to certain areas of the biometric area or may detect interaction using capacitive change in an area of biometric area. For example, referring to FIG. 1B, the user may interacts (e.g., contacts, taps, touches, depresses, swipes, etc.) with one of the icons 150, 160, 170, 180 displayed on the side display screen 130 (e.g., using the user's finger 101). Referring to FIG. 2B, the user may interact (e.g., contacts, taps, touches, depresses, swipes, etc.) with one of the icons 250, 260, 270, 280 displayed on the side display screen 230 (e.g., using the user's finger 201).

In FIG. 3A, at 318, the UE may determine if the at least one biometric is authenticated based on the second interaction. For example, the UE may capture a user's biometric information, compare the captured biometric information to biometric information stored for one or more users (e.g., user 1, user 2, user 3, etc.), determine if one of the stored biometric information matches the captured biometric information, and identify the user performing the second interaction as a particular user (e.g., user 1). In an aspect, the second interaction may cause the UE to enter an unlocked awake mode when the at least one biometric is authenticated. For example, referring to FIG. 1C, when the user interacts (e.g., contacts, taps, touches, depresses, swipes, etc.) with one of the icons 150, 160, 170, 180 displayed on the side display screen 130 (e.g., using the user's finger 101), the UE 100 may perform biometric authentication based on the user's captured fingerprint (e.g., determine if the user's fingerprint is authenticated). Referring to FIG. 2C, when the user interacts (e.g., contacts, taps, touches, depresses, swipes, etc.) with one of the icons 250, 260, 270, 280 displayed on the side display screen 230 (e.g., using the user's finger 201), the UE 200 may perform biometric authentication based on the user's captured fingerprint (e.g., determine if the user's fingerprint is authenticated).

In FIG. 3A, at 320, the UE may remain in a locked mode and stop the process of authentication when the at least one biometric is not authenticated based on the second interaction. For example, referring to FIGS. 1C and 2C, if the UE 100, 200 is not able to authenticate the biometric of the user, then the UE 100, 200 may remain in a locked mode.

In FIG. 3B, at 322, the UE may open an application in the set of applications associated with the one of the plurality of icons and unlock the UE when the at least one biometric is authenticated based on the second user action. In one aspect, application opened by the UE may be one in the set of applications. For example, referring to FIGS. 1C, 1D, 2C, and 2D, after the biometric of the first user is authenticated (e.g., as discussed supra with respect to FIGS. 1B and 2B), UE 100, 200 may enter the unlocked awake mode and automatically open a video-sharing application (e.g., when the second user interaction with an icon associated with a video-sharing application) without further interaction by the user.

In FIG. 3B, at 324, the UE may open an application in the set of applications associated with one of the plurality of icons by opening a first version of the application based on the first set of user characteristics when the first biometric is authenticated. For example, referring to FIG. 1C, a first video-sharing application (e.g., App₄ selected by the user in FIG. 1B) may be displayed automatically after the biometric of the first user is authenticated. Additionally, when the user selects the email application (e.g., App₁ in FIG. 1B), a version of the email application associated with the user's login credentials (e.g., the username and password used to gain access to the user's email account) is displayed automatically. In certain configurations, UE 100 may open the email application using the user's login credentials so that the user has automatic access to the email account. In other configurations, UE 100 may open the login page of the email application so that the user has to enter login credentials before gaining access to the email account. Referring to FIG. 2C, a first video-sharing application (e.g., App₄ selected by the user in FIG. 2B) may be displayed automatically after the biometric of the first user is authenticated. Additionally, when the user selects the email application (e.g., App₁ in FIG. 2B), a version of the email application associated with the user's login credentials (e.g., the username and password used to gain access to the user's email account) is displayed automatically. In certain configurations, UE 200 may open the email application using the user's login credentials so that the user has automatic access to the email account. In other configurations, UE 200 may open the login page of the email application so that the user has to enter login credentials before gaining access to the email account.

In FIG. 3B, at 326, the UE may open the first version of the application by displaying first content tailored to the first user based on the first set of user characteristics. For example, referring to FIGS. 1C and 2C, assume that the UE 100, 200 determines that the first user is particularly interested in politics based on the set of user characteristics associated with the first user. Then, the UE 100, 200 may open a version of the video-sharing application that provides the first user with a selection of trending political video content in the trending video section 135, 235 and the political podcasts the first user subscribes to in the subscriptions section 145, 245.

In FIG. 3B, at 328, the UE may open an application associated with one of the plurality of icons by opening a second version of the application based on the second set of user characteristics when the second biometric is authenticated. In one aspect, the first version of the application and the second version of the application may be different. For example, referring to FIG. 1D, a second version of the video-sharing application (e.g., App₄ selected by the user in FIG. 1B) may be displayed automatically after the biometric of the second user is authenticated. Referring to FIG. 2D, a second version of the video-sharing application (e.g., App₄ selected by the user in FIG. 2B) may be displayed automatically after the biometric of the second user is authenticated. Additionally, if a second user selects the email application (e.g., App₄ selected by the user in FIGS. 1B and 2B), a version of the email application associated with the second user's login credentials (e.g., the username and password used to gain access to the first user's email account) may be displayed automatically.

In FIG. 3B, at 330, the UE may open the second version of the application by displaying second content tailored to the second user based on the second set of user characteristics. For example, referring to FIGS. 1D and 2D, assume that the UE 100, 200 determines that the second user is particularly interested in sports based on the set of user characteristics associated with the second user. Then, the UE 100, 200 may open a version of the video-sharing application that provides the second user with a selection of trending sports highlights in the trending video section 135, 235 and the sports podcasts the second user subscribes to in the subscriptions section 145, 245.

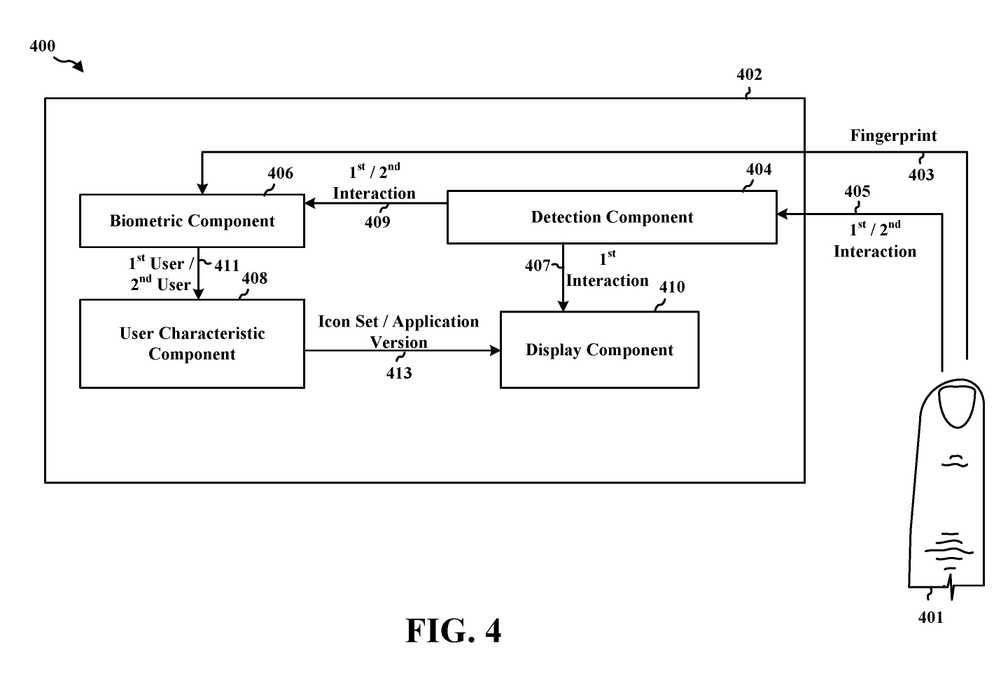

FIG. 4 is a conceptual data flow diagram 400 illustrating the data flow between different means/components in an exemplary apparatus 402. The apparatus may be a UE (e.g., UE 100, 200, the apparatus 402′). The apparatus 402 may include a biometric component 406 that stores and/or has access to biometric information (e.g., a fingerprint data file) that is formed using fingerprint data 403 obtained when a user's finger 401 is placed on a biometric area of the apparatus 402 (e.g., during a biometric set up procedure). Alternatively, the biometric information may be downloaded by the biometric component 406 from another device and/or server. In addition, biometric component 406 may associate biometric information for one or more users to a specific set of applications. In one aspect, biometric component 406 may store and/or have access to biometric information for a plurality of users (e.g., a first user and a second user). Biometric component 406 may store and/or have access to biometric information for a plurality of user when more than one user is enabled to gain access to the apparatus 402 (e.g., unlock the apparatus 402). In one aspect, biometric component 406 may associate biometric information for a specific user with a set of applications. For example, the set of applications may be selected by the user for application accessibility, as discussed supra. In addition, the apparatus 402 may include user characteristic component 408 that may associate a first set of user characteristics with the biometric information of the first user. Further, user characteristic component 408 may associate a second set of user characteristics with biometric information associated with the second user. In addition, apparatus 402 may include detection component 404 that may detect a first interaction 405 with the apparatus 402 when the apparatus 402 is in a locked mode. In one aspect, the first interaction may cause the UE to enter a locked awake mode. For example, detection component 404 may send a signal 407 associated with the first interaction to display component 410 when biometric authentication is not performed for the first interaction. Display component 410 may enter an awake mode and display a plurality of icons in a biometric area when the signal 407 is received. In an aspect, each of the plurality of icons may be associated with a different application in the set of applications selected by the user for application accessibility. For example, if the first user is the primary user of the device, the icons associated with the set of applications selected by the first user may be displayed whether the first interaction is by the first user or the second user. Alternatively, detection component 404 may send a signal 409 associated with the first interaction to biometric component 406. Biometric component 406 may determine if the at least one biometric is authenticated based on the first interaction. In addition, biometric component 406 may send a signal 415 to user characteristic component 408 indicating that a first user is authenticated the first interaction. User characteristic component 408 may determine a set of icons selected by the first user for display in the biometric area of the display screen. In addition, user characteristic component 408 may send a signal 413 associated with the set of icons selected by the first user. Display component 410 may display the plurality of icons based on the signal 413 received from the user characteristic component. In one aspect, the first interaction causes the apparatus 402 to enter a locked awake mode when the at least one biometric is authenticated based on the first interaction. Detection component 404 may detect a second interaction 405 with one of the plurality of icons displayed in the biometric area, and send a signal 409 associated with the second interaction to biometric component 406. Biometric component 406 may determine if biometric information for the first user or the second user is authenticated based on the second interaction. In an aspect, the second interaction may cause the apparatus 402 to enter an unlocked awake mode when the at least one biometric is authenticated. For example, biometric component 406 may send a signal 411 to user characteristic component 408 indicating whether the first or the second user is authenticated. User characteristic component 408 may send a signal 413 including information associated with a version of the application based on whether the first or second user is authenticated. Display component 410 may open a version of the application (e.g., the application may be associated with the icon the user interacts with) and the apparatus 402 may be unlocked when biometric information is authenticated based on the second user action. In one configuration, display component 410 may open a first version of the application based on the first set of user characteristics when biometric information of the first user is authenticated by biometric component 406. For example, display component 410 may open the first version of the application by displaying first content tailored to the first user when the signal 413 includes information associated first set of user characteristics. In another configuration, display component 410 may open a second version of the application based on the second set of user characteristics when biometric information of the second user is authenticated by biometric component 406. For example, display component 410 may open the second version of the application by displaying second content tailored to the second user when the signal 413 includes information associated second set of user characteristics. Alternatively, apparatus 402 may remain in a locked mode and stop the process of authentication when biometric information is not authenticated based on the second interaction.

The apparatus may include additional components that perform each of the blocks of the algorithm in the aforementioned flowcharts of FIGS. 3A and 3B. As such, each block in the aforementioned flowcharts of FIGS. 3A and 3B may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

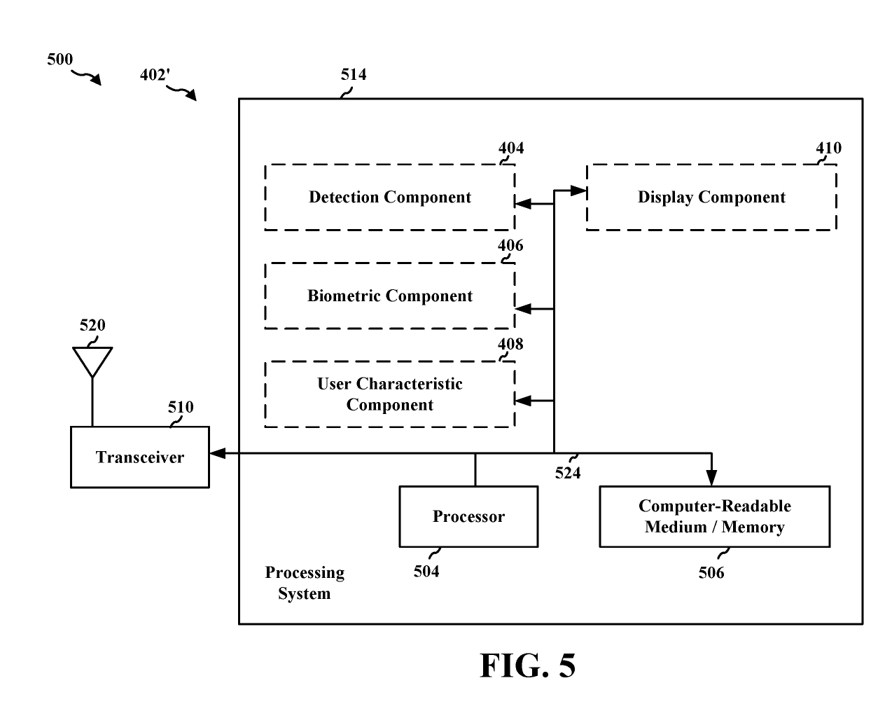

FIG. 5 is a diagram 500 illustrating an example of a hardware implementation for an apparatus 402′ employing a processing system 514. The processing system 514 may be implemented with a bus architecture, represented generally by the bus 524. The bus 524 may include any number of interconnecting buses and bridges depending on the specific application of the processing system 514 and the overall design constraints. The bus 524 links together various circuits including one or more processors and/or hardware components, represented by the processor 504, the components 404, 406, 408, 410 and the computer-readable medium/memory 506. The bus 524 may also link various other circuits such as timing sources, peripherals, voltage regulators, and power management circuits, which are well known in the art, and therefore, will not be described any further.

The processing system 514 may be coupled to a transceiver 510. The transceiver 510 is coupled to one or more antennas 520. The transceiver 510 provides a means for communicating with various other apparatus over a transmission medium. The transceiver 510 receives a signal from the one or more antennas 520, extracts information from the received signal, and provides the extracted information to the processing system 514. In addition, the transceiver 510 receives information from the processing system 514, and based on the received information, generates a signal to be applied to the one or more antennas 520. The processing system 514 includes a processor 504 coupled to a computer-readable medium/memory 506. The processor 504 is responsible for general processing, including the execution of software stored on the computer-readable medium/memory 506. The software, when executed by the processor 504, causes the processing system 514 to perform the various functions described supra for any particular apparatus. The computer-readable medium/memory 506 may also be used for storing data that is manipulated by the processor 504 when executing software. The processing system 514 further includes at least one of the components 404, 406, 408, 410. The components may be software components running in the processor 504, resident/stored in the computer readable medium/memory 506, one or more hardware components coupled to the processor 504, or some combination thereof.

In one configuration, the apparatus 402/402′ for wireless communication may include means for associating at least one biometric to a set of applications. In one aspect, the at least one biometric may be associated with each application in the set of applications. In another configuration, the apparatus 402/402′ for wireless communication may include means for associating a first set of user characteristics with a first biometric of the at least one biometric. In one aspect, the first set of user characteristics and the first biometric may be associated with a first user. In another aspect, the first set of user characteristics may include at least one of an age of the first user, a gender of the first user, a nationality of the first user, one of more hobbies of the first user, frequently searched content by the first user, recently searched content by the first user, music downloaded by the first user, video game preferences associated with the first user, or a location of the first user. In a further configuration, the apparatus 402/402′ for wireless communication may include means for associating a second set of user characteristics with a second biometric of the at least one biometric. In one aspect, the second set of user characteristics and the second biometric may be associated with a second user. In another aspect, the second set of user characteristics may include at least one of an age of the second user, a gender of the second user, a nationality of the second user, one of more hobbies of the second user, frequently searched content by the second user, recently searched content by the second user, music downloaded by the second user, video game preferences associated with the second user, or a location of the second user. In one configuration, the apparatus 402/402′ for wireless communication may include means for detecting a first interaction with the UE when the UE is in a locked state. In one aspect, the first interaction may cause the UE to enter a locked awake mode. In another configuration, the apparatus 402/402′ for wireless communication may include means for displaying a plurality of icons in a biometric area when the first interaction is detected. In a further configuration, the apparatus 402/402′ for wireless communication may include means for determining if the at least one biometric is authenticated based on the first interaction. In one aspect, the first interaction may cause the UE to enter a locked awake mode when the at least one biometric is authenticated based on the first interaction. In one aspect, each of the plurality of icons may be associated with a different application in the set of applications. In another aspect, the biometric area may be a portion of a display screen of the UE. In a further aspect, the biometric area may be located at one edge of the display screen. In a further configuration, the apparatus 402/402′ for wireless communication may include means for detecting a second interaction with one of the plurality of icons displayed in the biometric area. In one configuration, the apparatus 402/402′ for wireless communication may include means for determining if the at least one biometric is authenticated based on the second interaction. In an aspect, the second interaction may cause the UE to enter an unlocked awake mode when the at least one biometric is authenticated. In another configuration, the apparatus 402/402′ for wireless communication may include means for opening an application in the set of applications associated with the one of the plurality of icons and means for unlocking the UE when the at least one biometric is authenticated. In another aspect, the means for opening the application associated with the one of the plurality of icons may be configured to open a first version of the application based on the first set of user characteristics when the first biometric is authenticated. In further aspect, the means for opening the first version of the application may be configured to display first content tailored to the first user based on the first set of user characteristics. In another aspect, the means for opening the application associated with the one of the plurality of icons may be configured to open a second version of the application based on the second set of user characteristics when the second biometric is authenticated. For example the first version of the application and the second version of the application may be different. In a further aspect, the means for opening the second version of the application may be configured to display second content tailored to the second user based on the second set of user characteristics. The aforementioned means may be one or more of the aforementioned components of the apparatus 402 and/or the processing system 514 of the apparatus 402′ configured to perform the functions recited by the aforementioned means.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method for unlocking a user equipment (UE), comprising:
associating at least one biometric to a set of applications, the at least one biometric being associated with each application in the set of applications;
detecting a first interaction with the UE when the UE is in a locked mode;
displaying a plurality of icons in a biometric area based on the first interaction, each of the plurality of icons being associated with a different application in the set of applications;
detecting a second interaction with one of the plurality of icons displayed in the biometric area;
determining if the at least one biometric is authenticated based on the second interaction; and
opening an application in the set of applications associated with the one of the plurality of icons and unlocking the UE when the at least one biometric is authenticated.

2. The method of claim 1, further comprising:
determining if the at least one biometric is authenticated based on the first interaction,
wherein the first interaction causes the UE to enter a locked awake mode when the at least one biometric is authenticated based on the first interaction, and
wherein the second interaction causes the UE to enter an unlocked awake mode when the at least one biometric is authenticated based on the second interaction.

3. The method of claim 1, wherein the biometric area is a portion of a display screen of the UE.

4. The method of claim 3, wherein the biometric area is located at one edge of the display screen.

5. The method of claim 1, further comprising:
associating a first set of user characteristics with a first biometric of the at least one biometric, the first set of user characteristics and the first biometric being associated with a first user; and
associating a second set of user characteristics with a second biometric of the at least one biometric, the second set of user characteristics and the second biometric being associated with a second user.

6. The method of claim 5, wherein opening the application in the set of applications associated with the one of the plurality of icons comprises:
opening a first version of the application based on the first set of user characteristics when the first biometric is authenticated; or
opening a second version of the application based on the second set of user characteristics when the second biometric is authenticated, the first version of the application and the second version of the application being different.

7. The method of claim 6, wherein opening the first version of the application comprises:
displaying a first content tailored to the first user based on the first set of user characteristics.

8. The method of claim 7, wherein opening the second version of the application comprises:
displaying a second content tailored to the second user based on the second set of user characteristics.

9. The method of claim 6, wherein:
the first set of user characteristics include at least one of an age of the first user, a gender of the first user, a nationality of the first user, one of more hobbies of the first user, frequently searched content by the first user, recently searched content by the first user, music downloaded by the first user, video game preferences associated with the first user, or a location of the first user; and
the second set of user characteristics include at least one of an age of the second user, a gender of the second user, a nationality of the second user, one of more hobbies of the second user, frequently searched content by the second user, recently searched content by the second user, music downloaded by the second user, video game preferences associated with the second user, or a location of the second user.

10. An apparatus for unlocking a user equipment (UE), comprising:
means for associating at least one biometric to a set of applications, the at least one biometric being associated with each application in the set of applications;
means for detecting a first interaction with the UE when the UE is in a locked mode;
means for displaying a plurality of icons in a biometric area based on the first interaction, each of the plurality of icons being associated with a different application in the set of applications;
means for detecting a second interaction with one of the plurality of icons displayed in the biometric area;
means for determining if the at least one biometric is authenticated based on the second interaction; and
means for opening an application associated with the one of the plurality of icons and unlocking the UE when the at least one biometric is authenticated, the application being one in the set of applications.

11. The apparatus of claim 10, further comprising:
means for determining if the at least one biometric is authenticated based on the first interaction,
wherein the first interaction causes the UE to enter a locked awake mode when the at least one biometric is authenticated based on the first interaction, and
wherein the second interaction causes the UE to enter an unlocked awake mode when the at least one biometric is authenticated based on the second interaction.

12. The apparatus of claim 10, wherein the biometric area is a portion of a display screen of the UE.

13. The apparatus of claim 12, wherein the biometric area is located at one edge of the display screen.

14. The apparatus of claim 10, further comprising:
means for associating a first set of user characteristics with a first biometric of the at least one biometric, the first set of user characteristics and the first biometric being associated with a first user; and
means for associating a second set of user characteristics with a second biometric of the at least one biometric, the second set of user characteristics and the second biometric being associated with a second user.

15. The apparatus of claim 14, wherein the means for opening the application associated with the one of the plurality of icons is configured to:
open a first version of the application based on the first set of user characteristics when the first biometric is authenticated; or
open a second version of the application based on the second set of user characteristics when the second biometric is authenticated, the first version of the application and the second version of the application being different.

16. The apparatus of claim 15, wherein the means for opening the first version of the application is configured to:
display a first content tailored to the first user based on the first set of user characteristics.

17. The apparatus of claim 16, wherein the means for opening the second version of the application is configured to:
display a second content tailored to the second user based on the second set of user characteristics.

18. The apparatus of claim 15, wherein:
the first set of user characteristics include at least one of an age of the first user, a gender of the first user, a nationality of the first user, one of more hobbies of the first user, frequently searched content by the first user, recently searched content by the first user, music downloaded by the first user, video game preferences associated with the first user, or a location of the first user; and
the second set of user characteristics include at least one of an age of the second user, a gender of the second user, a nationality of the second user, one of more hobbies of the second user, frequently searched content by the second user, recently searched content by the second user, music downloaded by the second user, video game preferences associated with the second user, or a location of the second user.

19. An apparatus for unlocking a user equipment (UE), comprising:
a memory; and
at least one processor coupled to the memory and configured to:
associate at least one biometric to a set of applications, the at least one biometric being associated with each application in the set of applications;
detect a first interaction with the UE when the UE is in a locked mode;
display a plurality of icons in a biometric based on the first interaction, each of the plurality of icons being associated with a different application in the set of applications;
detect a second interaction with one of the plurality of icons displayed in the biometric area;
determine if the at least one biometric is authenticated based on the second interaction; and
open an application associated with the one of the plurality of icons and unlocking the UE when the at least one biometric is authenticated, the application being one in the set of applications.

20. The apparatus of claim 19, wherein the at least one processor is further configured to:
determine if the at least one biometric is authenticated based on the first interaction,
wherein the first interaction causes the UE to enter a locked awake mode when the at least one biometric is authenticated based on the first interaction, and
wherein the second interaction causes the UE to enter an unlocked awake mode when the at least one biometric is authenticated based on the second interaction.

21. The apparatus of claim 19, wherein the biometric area is a portion of a display screen of the UE.

22. The apparatus of claim 21, wherein the biometric area is located at one edge of the display screen.

23. The apparatus of claim 19, wherein the at least one processor is further configured to:
associate a first set of user characteristics with a first biometric of the at least one biometric, the first set of user characteristics and the first biometric being associated with a first user; and
associate a second set of user characteristics with a second biometric of the at least one biometric, the second set of user characteristics and the second biometric being associated with a second user.

24. The apparatus of claim 23, wherein the at least one processor is configured to open the application associated with the one of the plurality of icons by:
opening a first version of the application based on the first set of user characteristics when the first biometric is authenticated; or
opening a second version of the application based on the second set of user characteristics when the second biometric is authenticated, the first version of the application and the second version of the application being different.

25. The apparatus of claim 24, wherein the at least one processor is configured to open the first version of the application by:
displaying a first content tailored to the first user based on the first set of user characteristics.

26. The apparatus of claim 25, wherein the at least one processor is configured to open the second version of the application by:
displaying a second content tailored to the second user based on the second set of user characteristics.

27. The apparatus of claim 24, wherein:
the first set of user characteristics include at least one of an age of the first user, a gender of the first user, a nationality of the first user, one of more hobbies of the first user, frequently searched content by the first user, recently searched content by the first user, music downloaded by the first user, video game preferences associated with the first user, or a location of the first user; and
the second set of user characteristics include at least one of an age of the second user, a gender of the second user, a nationality of the second user, one of more hobbies of the second user, frequently searched content by the second user, recently searched content by the second user, music downloaded by the second user, video game preferences associated with the second user, or a location of the second user.

28. A computer-readable medium storing computer executable code for unlocking a user equipment (UE), comprising code to:
associate at least one biometric to a set of applications, the at least one biometric being associated with each application in the set of applications;
detect a first interaction with the UE when the UE is in a locked mode;
display a plurality of icons in a biometric area when the first interaction is detected, each of the plurality of icons being associated with a different application in the set of applications;
detect a second interaction with one of the plurality of icons displayed in the biometric area;
determine if the at least one biometric is authenticated based on the second interaction; and
open an application associated with the one of the plurality of icons and unlocking the UE when the at least one biometric is authenticated, the application being one in the set of applications.

29. The computer-readable medium of claim 28, wherein the first interaction causes the UE to enter a locked awake mode and the second interaction causes the UE to enter an unlocked awake mode when the at least one biometric is authenticated.

30. The computer-readable medium of claim 28, wherein the biometric area is a portion of a display screen of the UE.
